(19) United States
(12) Patent Application Publication
(10) Pub. No.: US 2026/0180638 A1
(43) Pub. Date: Jun. 25, 2026

(54) METHOD OF COORDINATED BEAMFORMING IN WLAN AND RELATED APPARATUS

(71) Applicant: GUANGDONG OPPO MOBILE TELECOMMUNICATIONS CORP., LTD., Dongguan (CN)

(72) Inventor: Dong WEI, Dongguan (CN)

(21) Appl. No.: 19/425,428

(22) Filed: Dec. 18, 2025

Related U.S. Application Data
(60) Provisional application No. 63/738,051, filed on Dec. 23, 2024.

(51) Int. Cl. H04B 7/06; H04W 84/12

(52) U.S. Cl. CPC H04B 7/0617; H04W 84/12

(57) ABSTRACT

A method of coordinated beamforming performed by an access point (AP) device in a wireless local area network (WLAN) includes determining, by the AP device as an initiating AP device, a set of configurations for downlink data transmissions to selected stations, wherein the set of configurations includes at least one of a transmission channel bandwidth, a number of spatial streams per station, or a number of transmit chains.

### CROSS REFERENCE TO RELATED APPLICATIONS

This application claims priority to U.S. Provisional Application No. 63/738,051, filed Dec. 23, 2024, the entire disclosure of which is incorporated herein by reference.

### TECHNICAL FIELD

The present disclosure relates to the field of communication systems, and more particularly, to a method of coordinated beamforming performed by an access point (AP) device in a wireless local area network (WLAN) and related apparatus.

### BACKGROUND

Wireless local area networks (WLANs) support multiple access point (AP) devices and non-AP stations. Coordinated beamforming (COBF) has been proposed to enable AP devices from different basic service sets (BSSs) to cooperate and mitigate inter-BSS interference. Existing techniques generally provide solutions for identification of peer COBF AP devices and associated non-AP stations.

However, such existing techniques suffer from several drawbacks. First, the non-AP stations that participate in COBF are selected on a per-transmission opportunity (TXOP) basis only after a channel sounding procedure is performed. This approach requires a large number of non-AP stations to participate in sounding, thereby causing COBF AP devices to store and manage a significant amount of channel state information (CSI) data. Second, the important issue of fairness in TXOP sharing among multiple AP devices is not addressed. Third, no adequate solution has been provided for terminating an existing COBF configuration, even though termination is necessary for COBF devices to release occupied resources when conditions for COBF are no longer valid.

Therefore, there is a need for apparatuses and methods of wireless communication.

### SUMMARY

An object of the present disclosure is to propose a method of coordinated beamforming performed by an access point (AP) device in a wireless local area network (WLAN) and related apparatus, which can solve issues in the prior art and other issues, reduce sounding overhead, ensure fairness in multi-AP TXOP sharing, and/or enable termination of coordinated beamforming to release resources when no longer needed.

In a first aspect of the present disclosure, a method of coordinated beamforming performed by an access point (AP) device in a wireless local area network (WLAN) includes determining, by the AP device as an initiating AP device, a set of configurations for downlink data transmissions to selected stations, wherein the set of configurations includes at least one of a transmission channel bandwidth, a number of spatial streams per station, or a number of transmit chains.

In a second aspect of the present disclosure, an AP device includes a determiner. The determiner is configured to determine a set of configurations for downlink data transmissions to selected stations, wherein the set of configurations includes at least one of a transmission channel bandwidth, a number of spatial streams per station, or a number of transmit chains.

In a third aspect of the present disclosure, an AP device includes a memory, a transceiver, and a processor coupled to the memory and the transceiver. The AP is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1A is a diagram illustrating an example of coordinated beamforming (Co-BF) communication between a coordinating AP and a coordinated AP according to an embodiment of the present disclosure.

FIG. 1B is a diagram illustrating an example of Co-BF communication between a coordinating AP and a coordinated AP according to an embodiment of the present disclosure.

FIG. 1C is a block diagram of one or more AP devices and one or more non-AP stations of communication in a communication network system according to an embodiment of the present disclosure.

FIG. 2 is a block diagram of one or more AP devices according to an embodiment of the present disclosure.

FIG. 3 is a block diagram of one or more AP devices according to an embodiment of the present disclosure.

FIG. 4 is a flowchart illustrating a method of coordinated beamforming performed by an access point (AP) device in a wireless local area network (WLAN) according to an embodiment of the present disclosure.

FIG. 5 is a block diagram of an example of a computing device according to an embodiment of the present disclosure.

FIG. 6 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Some embodiments of the present disclosure provide an exemplary method by which two access point (AP) devices in a wireless local area network (WLAN) establish a mutual agreement for coordinated beamforming (COBF), enabling the AP devices to cooperatively manage downlink transmissions, mitigate interference across overlapping basic service sets (BSSs), and improve overall system efficiency and throughput.

In some embodiments of the present disclosure, the terms “coordinating access point (coordinating AP)” and “coordinated access point (coordinated AP)” follow the definitions provided in the description. In details, coordinated beamforming coordinating access point (Co-BF coordinating AP): A coordinating AP that initiates a coordinated beamforming (Co-BF) transmission with another AP. Coordinated beamforming coordinated access point (Co-BF coordinated AP): A coordinated AP that participates in a Co-BF transmission initiated by the Co-BF coordinating AP. Accordingly, in some embodiments of the present disclosure, the “initiating AP device” corresponds to the Co-BF coordinating AP, and the “responding AP device” corresponds to the Co-BF coordinated AP. In some embodiments of the present disclosure, “an initiating AP” corresponds to a coordinating AP, and “a responding AP” corresponds to a coordinated AP. These definitions are used interchangeably in some embodiments of the present disclosure to describe the functional relationship between multiple AP devices performing coordinated beamforming operations.

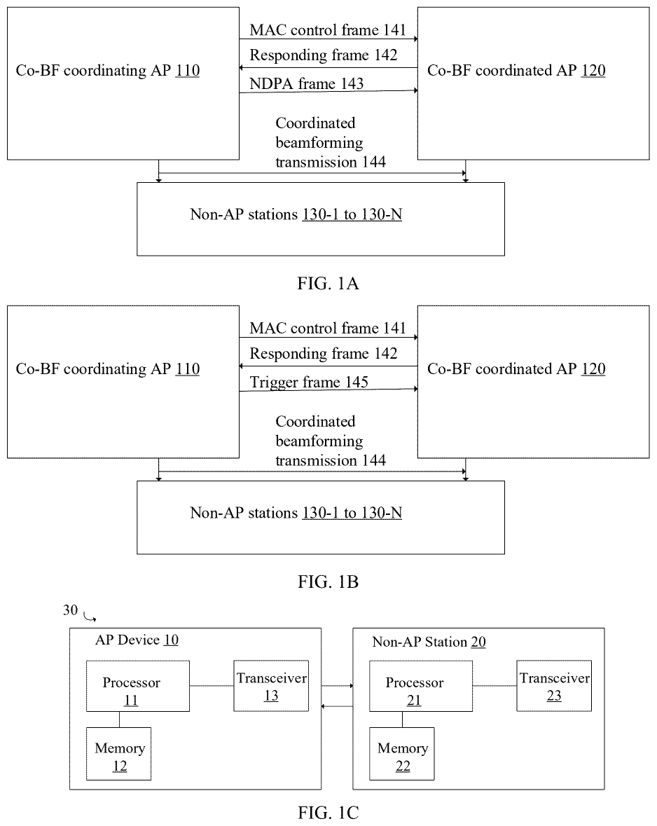

FIG. 1A illustrates an example of coordinated beamforming (Co-BF) communication between two access points (APs). In this embodiment, a Co-BF coordinating AP 110, also referred to as the initiating AP device, initiates a Co-BF operation by transmitting a medium access control (MAC) control frame 141 to a Co-BF coordinated AP 120, also referred to as the responding AP device. The Co-BF coordinated AP 120 may transmit a responding frame 142 to indicate participation in the coordinated beamforming procedure. The Co-BF coordinating AP 110 then transmits a null data packet announcement (NDPA) frame 143 to initiate a sounding operation for obtaining channel state information (CSI) from a plurality of non-AP stations 130-1 to 130-N. After acquiring CSI, both Co-BF coordinating AP 110 and the Co-BF coordinated AP 120 jointly perform a coordinated beamforming transmission 144 to the non-AP stations. FIG. 1A illustrates the logical relationship between the coordinating/coordinated APs and the corresponding initiating/responding APs as described in some embodiments. In details, in some embodiments, the “initiating AP device” corresponds to the Co-BF coordinating AP or a coordinating AP, and the “responding AP device” corresponds to the Co-BF coordinated AP or a coordinated AP.

FIG. 1B illustrates an example of coordinated beamforming (Co-BF) communication between two access points (APs). In this embodiment, a Co-BF coordinating AP 110, also referred to as the initiating AP device, initiates a Co-BF operation by transmitting a medium access control (MAC) control frame 141 to a Co-BF coordinated AP 120, also referred to as the responding AP device. The Co-BF coordinated AP 120 may transmit a responding frame 142 to indicate participation in the coordinated beamforming procedure. The Co-BF coordinating AP 110 then transmits a trigger frame 145 to initiate a sounding operation for obtaining channel state information (CSI) from a plurality of non-AP stations 130-1 to 130-N. After acquiring CSI, both Co-BF coordinating AP 110 and the Co-BF coordinated AP 120 jointly perform a coordinated beamforming transmission 144 to the non-AP stations. FIG. 1A illustrates the logical relationship between the coordinating/coordinated APs and the corresponding initiating/responding APs as described in some embodiments. In details, in some embodiments, the “initiating AP device” corresponds to the Co-BF coordinating AP or a coordinating AP, and the “responding AP device” corresponds to the Co-BF coordinated AP or a coordinated AP.

FIG. 1C illustrates that, in some embodiments, one or more AP devices 10 and non-AP stations 20 of communication in a communication network system 30 according to an embodiment of the present disclosure are provided. The communication network system 30 includes the one or more AP devices 10 and the non-AP stations 20. The one or more AP devices 10 may include a memory 12, a transceiver 13, and a processor 11 coupled to the memory 12 and the transceiver 13. The non-AP stations 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to determine a set of configurations for downlink data transmissions to selected stations, wherein the set of configurations includes at least one of a transmission channel bandwidth, a number of spatial streams per station, or a number of transmit chains. This can solve issues in the prior art and other issues, reduce sounding overhead, ensure fairness in multi-AP TXOP sharing, and/or enable termination of coordinated beamforming to release resources when no longer needed.

In some embodiments, the processor 303 is configured to select one or more stations among associated non-AP stations based on at least one of a buffer status of downlink traffic or an active service period of the stations. In some embodiments, the transceiver 13 is configured to transmit a medium access control (MAC) control frame packet to a plurality of candidate AP devices from overlapping basic service sets (BSSs) to invite participation in coordinated beamforming. In some embodiments, the MAC control frame packet includes the set of configurations. In some embodiments, the MAC control frame packet indicates whether full nulling is required and a tolerable performance degradation. In some embodiments, the tolerable performance degradation includes a reduction in a signal-to-interference-noise ratio (SINR) at a receiver of one of selected non-AP stations. In some embodiments, the MAC control frame packet transmitted by the initiating AP device is an initial control frame or a trigger frame. In some embodiments, the transceiver 13 is configured to receive one or more responding frame packets, wherein the one or more responding frame packets includes an identification of one or more stations for coordinated beamforming.

Some embodiments describe how the transceiver 13 of the initiating AP device invites participation in coordinated beamforming by transmitting a MAC control frame to candidate AP devices in overlapping BSSs, where the frame includes transmission configurations, requirements for full nulling, and tolerable performance degradation; the transceiver 13 then receives responding frames from the candidate AP devices, each identifying stations selected for coordinated beamforming, thereby enabling efficient coordination among AP devices.

In some embodiments, the processor 11 is configured to select one of the plurality of candidate AP devices as a responding AP device for coordinated beamforming based on the one or more responding frame packets. In some embodiments, the transceiver 13 is configured to transmit a null data packet announcement (NDPA) frame to initiate a sounding operation to acquire a channel state information (CSI) from participating non-AP stations to both the initiating AP device and the responding AP device. In some embodiments, the processor 11 is configured to initiate a sounding operation to acquire a channel state information (CSI) from participating non-AP stations to both the initiating AP device and the responding AP device. In some embodiments, the NDPA frame transmitted by the initiating AP device further instructs the responding AP device to perform channel sounding. In some embodiments, the processor 11 is configured to transmit a trigger frame to trigger a downlink data transmission jointly with the responding AP device using coordinated beamforming. In some embodiments, the processor 11 is configured to terminate coordinated beamforming by transmitting a MAC control frame to suspend coordinated beamforming. In some embodiments, the transceiver 13 is configured to transmit a MAC frame to the responding AP device to suspend coordinated beamforming or receive the MAC frame from the responding AP device indicating suspension of coordinated beamforming. In some embodiments, the MAC frame is an NDPA frame or a trigger frame. In some embodiments, the processor 11 is configured to initiate a sounding operation to acquire a CSI from participating non-AP stations to both the initiating AP device and the responding AP device. In some embodiments, the NDPA frame transmitted by the initiating AP device further instructs the responding AP device to perform channel sounding. In some embodiments, the processor 11 is configured to transmit a trigger frame to trigger a downlink data transmission jointly with the responding AP device using coordinated beamforming. In some embodiments, the coordinated beamforming is terminated by the responding AP device by transmitting a MAC control frame to suspend coordinated beamforming. In some embodiments, terminating coordinated beamforming includes transmitting, by the initiating AP device, a MAC frame to the responding AP device to suspend coordinated beamforming; or receiving, by the initiating AP device, the MAC frame from the responding AP device indicating suspension of coordinated beamforming. In some embodiments, the MAC frame is an NDPA frame or a trigger frame.

Some embodiments describe how the processor 11 of the initiating AP device selects a responding AP device for coordinated beamforming based on received response frames, and how the transceiver 13 transmits an NDPA frame to confirm participation, initiate channel sounding, and acquire CSI from participating stations; the processor 11 then triggers joint downlink transmission with the responding AP using coordinated beamforming, and either the processor 11 or transceiver 13 may subsequently terminate the coordination by transmitting or receiving a control frame indicating suspension of the coordinated beamforming.

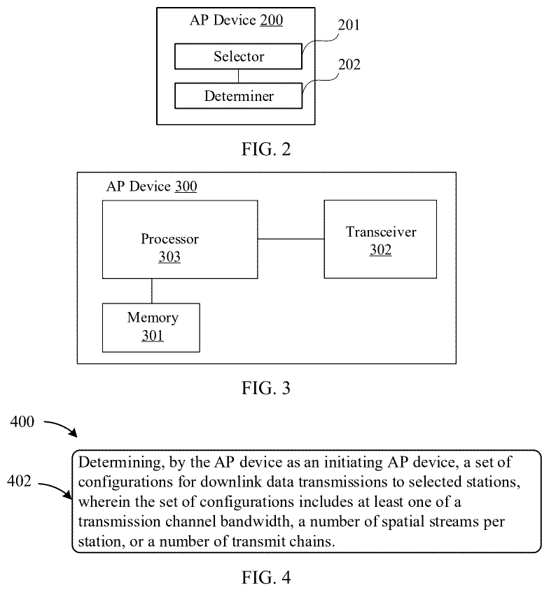

FIG. 2 illustrates an example of an AP device 200 according to an embodiment of the present application. The AP device 200 is configured to implement some embodiments of the disclosure. Some embodiments of the disclosure may be implemented into the AP device 200 using any suitably configured hardware and/or software. The AP device 200 includes a selector 201 and/or a determiner 202. The determiner 202 is configured to determine a set of configurations for downlink data transmissions to selected stations, wherein the set of configurations includes at least one of a transmission channel bandwidth, a number of spatial streams per station, or a number of transmit chains. This can solve issues in the prior art and other issues, reduce sounding overhead, ensure fairness in multi-AP TXOP sharing, and/or enable termination of coordinated beamforming to release resources when no longer needed.

In some embodiments, the selector 201 is configured to select one or more stations among associated non-AP stations based on at least one of a buffer status of downlink traffic or an active service period of the stations, In some embodiments, the determiner 202 is configured to transmit a medium access control (MAC) control frame packet to invite participation in coordinated beamforming. In some embodiments, the MAC control frame packet includes the set of configurations. In some embodiments, the MAC control frame packet indicates whether full nulling is required and a tolerable performance degradation. In some embodiments, the tolerable performance degradation includes a reduction in a signal-to-interference-noise ratio (SINR) at a receiver of one of selected non-AP stations. In some embodiments, the MAC control frame packet transmitted by the initiating AP device is an initial control frame or a trigger frame. In some embodiments, the determiner 202 is configured to receive one or more responding frame packets, wherein the one or more responding frame packets includes an identification of one or more stations for coordinated beamforming. In some embodiments, the selector 201 is configured to select one of the plurality of candidate AP devices as a responding AP device for coordinated beamforming based on the one or more responding frame packets. In some embodiments, the determiner 202 is configured to transmit a null data packet announcement (NDPA) frame to initiate a sounding operation to acquire a channel state information (CSI) from participating non-AP stations to both the initiating AP device and the responding AP device. In some embodiments, the determiner 202 is configured to initiate a sounding operation to acquire a channel state information (CSI) from participating non-AP stations to both the initiating AP device and the responding AP device. In some embodiments, the NDPA frame transmitted by the initiating AP device further instructs the responding AP device to perform channel sounding. In some embodiments, the determiner 202 is configured to transmit a trigger frame to trigger a downlink data transmission jointly with the responding AP device using coordinated beamforming. In some embodiments, the determiner 202 is configured to terminate coordinated beamforming by transmitting a MAC control frame to suspend coordinated beamforming. In some embodiments, the determiner 202 is configured to transmit a MAC frame to the responding AP device to suspend coordinated beamforming or receive the MAC frame from the responding AP device indicating suspension of coordinated beamforming. In some embodiments, the MAC frame is an NDPA frame or a trigger frame.

Some embodiments illustrate how the determiner 202 of the initiating AP device coordinates the overall COBF procedure by transmitting a MAC control frame to candidate AP devices with configuration details, nulling requirements, and tolerable performance degradation, receiving response frames with identified stations, and enabling the selector to choose a responding AP device; the determiner 202 then confirms participation by transmitting an NDPA frame, initiates channel sounding to acquire CSI, and triggers joint downlink transmission with the responding AP device based on the CSI, while also providing mechanisms for either AP to suspend or terminate the coordinated beamforming through control frame exchanges.

FIG. 3 illustrates an example of an AP device 300 according to an embodiment of the present disclosure. The AP device 300 is configured to implement some embodiments of the disclosure. Some embodiments of the disclosure may be implemented into the AP device 300 using any suitably configured hardware and/or software. The AP device 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the processor 303 is configured to determine a set of configurations for downlink data transmissions to selected stations, wherein the set of configurations includes at least one of a transmission channel bandwidth, a number of spatial streams per station, or a number of transmit chains. This can solve issues in the prior art and other issues, reduce sounding overhead, ensure fairness in multi-AP TXOP sharing, and/or enable termination of coordinated beamforming to release resources when no longer needed.

In some embodiments, the processor 303 is configured to select one or more stations among associated non-AP stations based on at least one of a buffer status of downlink traffic or an active service period of the stations. In some embodiments, the transceiver 302 is configured to transmit a medium access control (MAC) control frame packet to invite participation in coordinated beamforming. In some embodiments, the MAC control frame packet includes the set of configurations. In some embodiments, the MAC control frame packet indicates whether full nulling is required and a tolerable performance degradation. In some embodiments, the tolerable performance degradation includes a reduction in a signal-to-interference-noise ratio (SINR) at a receiver of one of selected non-AP stations. In some embodiments, the MAC control frame packet transmitted by the initiating AP device is an initial control frame or a trigger frame. In some embodiments, the transceiver 302 is configured to receive one or more responding frame packets, wherein the one or more responding frame packets includes an identification of one or more stations. In some embodiments, the processor 303 is configured to select one of the plurality of candidate AP devices as a responding AP device for coordinated beamforming based on the one or more responding frame packets. In some embodiments, the transceiver 302 is configured to transmit a null data packet announcement (NDPA) frame to initiate a sounding operation to acquire a channel state information (CSI) from participating non-AP stations to both the initiating AP device and the responding AP device. In some embodiments, the processor 303 is configured to initiate a sounding operation to acquire a channel state information (CSI) from participating non-AP stations to both the initiating AP device and the responding AP device. In some embodiments, the NDPA frame transmitted by the initiating AP device further instructs the responding AP device to perform channel sounding. In some embodiments, the processor 303 is configured to transmit a trigger frame to trigger a downlink data transmission jointly with the responding AP device using coordinated beamforming. In some embodiments, the processor 303 is configured to terminate coordinated beamforming by transmitting a MAC control frame to suspend coordinated beamforming. In some embodiments, the transceiver 302 is configured to transmit a MAC frame to the responding AP device to suspend coordinated beamforming or receive the MAC frame from the responding AP device indicating suspension of coordinated beamforming. In some embodiments, the MAC frame is an NDPA frame or a trigger frame. In some embodiments, the processor 303 is configured to initiate a sounding operation to acquire a CSI from participating non-AP stations to both the initiating AP device and the responding AP device. In some embodiments, the NDPA frame transmitted by the initiating AP device further instructs the responding AP device to perform channel sounding. In some embodiments, the processor 303 is configured to transmit a trigger frame to trigger a downlink data transmission jointly with the responding AP device using coordinated beamforming. In some embodiments, the coordinated beamforming is terminated by the responding AP device by transmitting a MAC control frame to suspend coordinated beamforming. In some embodiments, terminating coordinated beamforming includes transmitting, by the initiating AP device, a MAC frame to the responding AP device to suspend coordinated beamforming; or receiving, by the initiating AP device, the MAC frame from the responding AP device indicating suspension of coordinated beamforming. In some embodiments, the MAC frame is an NDPA frame or a trigger frame.

Some embodiments describe an initiating AP device in which the transceiver 302 invites coordinated beamforming by sending a MAC control frame with configuration details, nulling requirements, and tolerable performance degradation to candidate AP devices, and receives response frames identifying selected stations; the processor 303 then selects a responding AP device, the transceiver 302 confirms participation with an NDPA frame and initiates channel sounding to obtain CSI from participating stations, and the processor 303 triggers joint downlink transmission with the responding AP based on the CSI, while both the transceiver 302 and processor 303 support suspension or termination of coordinated beamforming through control frame exchanges.

FIG. 4 is an example of a method 400 of wireless communication performed by a AP device according to an embodiment of the present disclosure. The method 400 of wireless communication performed by the AP device is configured to implement some embodiments of the disclosure. Some embodiments of the disclosure may be implemented into the method 400 of wireless communication performed by the AP device using any suitably configured hardware and/or software. In some embodiments, the method 400 of wireless communication performed by the AP device includes: an operation 402, determining, by the AP device as an initiating AP device, a set of configurations for downlink data transmissions to selected stations, wherein the set of configurations includes at least one of a transmission channel bandwidth, a number of spatial streams per station, or a number of transmit chains. This can solve issues in the prior art and other issues, reduce sounding overhead, ensure fairness in multi-AP TXOP sharing, and/or enable termination of coordinated beamforming to release resources when no longer needed.

In some embodiments, the method further includes selecting one or more stations among associated non-AP stations based on at least one of a buffer status of downlink traffic or an active service period of the stations. In some embodiments, the method further includes transmitting, by the initiating AP device, a medium access control (MAC) control frame packet to invite participation in coordinated beamforming. In some embodiments, the MAC control frame packet includes the set of configurations. In some embodiments, the MAC control frame packet indicates whether full nulling is required and a tolerable performance degradation. In some embodiments, the tolerable performance degradation includes a reduction in a signal-to-interference-noise ratio (SINR) at a receiver of one of selected non-AP stations. In some embodiments, the MAC control frame packet transmitted by the initiating AP device is an initial control frame or a trigger frame. In some embodiments, the method further includes receiving, by the initiating AP device, one or more responding frame packets, wherein the one or more responding frame packets includes an identification of one or more stations.

In some embodiments, the method further includes selecting, by the initiating AP device, one of the plurality of candidate AP devices as a responding AP device for coordinated beamforming based on the one or more responding frame packets. In some embodiments, the method further includes transmitting, by the initiating AP device, a null data packet announcement (NDPA) frame to initiate a sounding operation to acquire a channel state information (CSI) from participating non-AP stations to both the initiating AP device and the responding AP device. In some embodiments, the method further includes initiating a sounding operation to acquire a channel state information (CSI) from participating non-AP stations to both the initiating AP device and the responding AP device. In some embodiments, the NDPA frame transmitted by the initiating AP device further instructs the responding AP device to perform channel sounding. In some embodiments, the method further include transmitting a trigger frame, by the initiating AP device, to trigger a downlink data transmission jointly with the responding AP device using coordinated beamforming. In some embodiments, the method further include terminating, by at least one of the initiating AP device or the responding AP device, coordinated beamforming by transmitting a MAC control frame to suspend coordinated beamforming. In some embodiments, coordinated beamforming is terminated by the responding AP device by transmitting a MAC control frame to suspend coordinated beamforming. In some embodiments, terminating coordinated beamforming includes transmitting, by the initiating AP device, a MAC frame to the responding AP device to suspend coordinated beamforming or receiving, by the initiating AP device, the MAC frame from the responding AP device indicating suspension of coordinated beamforming. In some embodiments, the MAC frame is an NDPA frame or a trigger frame.

Some embodiment illustrate a method of wireless communication performed by an initiating AP device that selects non-AP stations based on buffer status or active service periods, determines transmission configurations, and transmits a MAC control frame to candidate AP devices in overlapping BSSs to invite participation in coordinated beamforming; the candidate APs respond with identified stations, enabling the initiating AP to select a responding AP device, confirm participation with an NDPA frame, and initiate sounding to obtain CSI, after which the initiating and responding APs perform joint downlink transmission with coordinated beamforming, while also providing mechanisms for either AP to terminate the coordination through control frame exchanges to release resources when no longer needed.

### Exemplary Technical Solutions

Wi-Fi access points used in home, small office, and enterprise environments (such as wireless routers, broadband gateways, and mesh Wi-Fi systems) can support coordinated beamforming in a wireless local area network, a technology that allows access point devices from different basic service sets (BSSs) to coordinate the use of multiple transmit antennas in order to reduce interference across BSSs. An initiating AP device is an access point that begins coordinated beamforming with other AP devices and offers to share its future transmission opportunities (TXOPs) with them.

In some examples, a method of coordinated beamforming in a wireless local area network (WLAN) includes at least one of the following operations:
1) The initiating AP device selects one or more stations from all its associated non-AP stations. This selection is based on the buffer status of downlink traffic and/or the active service periods for these stations. The initiating AP device selects one or more associated non-AP stations based on downlink buffer status and/or active service periods.
2) The initiating AP device determines a set of configurations for the downlink data transmissions to the selected stations. The set includes transmission channel bandwidth, the number of spatial streams for each station, and the number of transmit chains. The initiating AP device determines transmission configurations for the selected stations, including channel bandwidth, spatial streams, and transmit chains.
3) The initiating AP device transmits an MAC control frame packet (e.g. an initial control frame or a trigger frame) to multiple candidate AP devices to invite participation in coordinated beamforming. The control frame packet contains the set of configurations for the downlink data transmissions from the initial AP device to its selected non-AP stations. In addition, the control frame packet indicates whether full nulling is required (i.e., no degradation in performance) and how much performance degradation (e.g. reduction in signal-to-interference-noise ratio (SINR) at the corresponding receiver) it can tolerate. The candidate AP devices are from the overlapping basic service sets of the initial AP device. The initiating AP device transmits a MAC control frame with transmission configurations, nulling requirements, and tolerable performance degradation to candidate AP devices in overlapping BSSs to invite participation in coordinated beamforming.
4) Upon receiving the control frame packet from the initiating AP device, if a candidate AP device intends to participate in coordinated beamforming with the initiating AP device, it selects one or more stations from all its associated non-AP stations and transmits a responding frame packet to the initiating AP device to indicate its intention with the identification of its selected non-AP stations for coordinated beamforming. A candidate AP device that intends to participate selects one or more of its associated non-AP stations and sends a responding frame to the initiating AP with their identification.
5) Upon receiving the responding frame packets from all the interested candidate AP devices, the initiating AP device selects one of them for coordinated beamforming. The chosen AP device becomes a responding AP device for coordinated beamforming. The initiating AP device transmits a null data packet announcement (NDPA) frame to the responding AP device to confirm the acceptance of the latter's participation in coordinated beamforming and start a sounding operation to acquire channel state information from all the participating non-AP stations to itself and to the responding AP device. The initiating AP selects one candidate AP as the responding AP, confirms participation by sending an NDPA frame, and initiates sounding to obtain CSI from all participating non-AP stations.
6) Having acquired the channel state information required for coordinated beamforming, the initiating AP triggers downlink data transmission jointly with the responding AP device with coordinated beamforming being applied to the transmission. The initiating AP, after acquiring the necessary CSI, triggers joint downlink transmission with the responding AP using coordinated beamforming.
7) Either the initiating AP device or the responding AP device may terminate this coordination. a. The initiating AP device transmits an MAC control frame (e.g., an NDPA frame or a trigger frame) to the responding AP device to suspend coordinated beamforming. b. . . . The responding AP device transmits an MAC control frame (e.g., response to a trigger frame transmitted from the initiating AP device) to the initiating AP device to suspend coordinated beamforming. Either the initiating AP or the responding AP may terminate coordinated beamforming by transmitting a MAC control frame to suspend the coordination.

Some embodiments of the present disclosure provide at least one of the following technical benefits. (1) It introduces a solution for determining non-AP stations and a responding AP device for coordinated beamforming (COBF) prior to the sounding operation, thereby minimizing the number of non-AP stations involved in sounding, reducing overhead, and achieving higher throughput. (2) It proposes the application of a fairness criterion, which is essential for ensuring equitable transmission opportunity (TXOP) sharing across multiple AP devices. (3) It provides a termination mechanism for COBF, an aspect not addressed in prior art, allowing devices to release resources when coordinated beamforming is no longer required.

In summary, some embodiments of the present disclosure describe exemplary methods and systems for coordinated beamforming (COBF) in wireless local area networks, where an initiating AP device selects non-AP stations based on traffic buffer status or active service periods, determines transmission configurations, and transmits MAC control frames with configuration and performance parameters to candidate AP devices in overlapping BSSs; candidate APs respond with their selected stations, enabling the initiating AP to choose a responding AP, confirm participation with an NDPA frame, initiate channel sounding, and acquire CSI for joint downlink transmission with coordinated beamforming, while also providing mechanisms for either AP to terminate coordination through control frame exchanges; these embodiments reduce sounding overhead, improve fairness in multi-AP TXOP sharing, and introduce a termination mechanism for COBF that is absent in prior art.

Commercial interests for some embodiments are as follows. 1. Solve issues in the prior art and other issues. 2. Reduce sounding overhead. 3. Ensure fairness in multi-AP TXOP sharing. 4. Enable termination of coordinated beamforming to release resources when no longer needed. 5. Provide a good communication performance. 6. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of wireless communication are considered for standardizing.

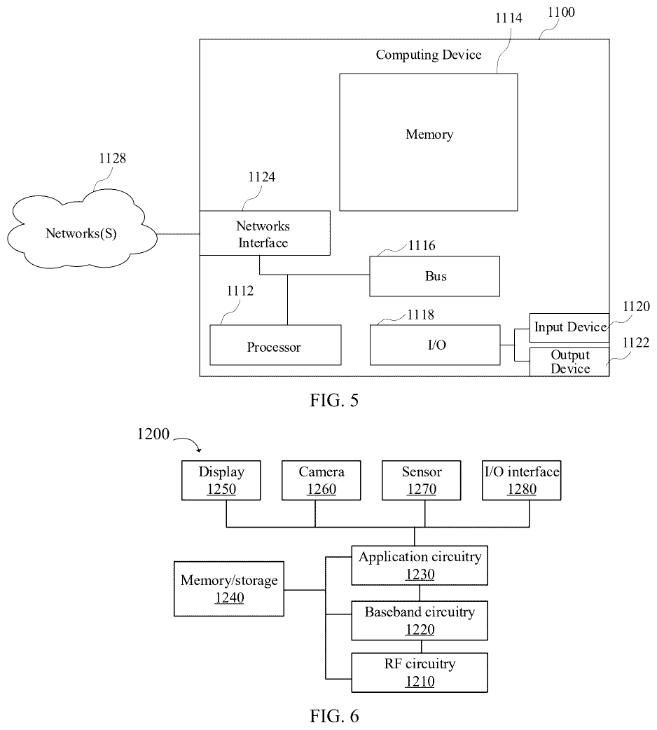

FIG. 5 is an example of a computing device 1100 according to an embodiment of the present disclosure. Any suitable computing device can be used for performing the operations described herein. For example, FIG. 5 illustrates an example of the computing device 1100 that can implement some embodiments of FIG. 1A to FIG. 4 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1A to FIG. 4. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 6 is a block diagram of an example of a communication system 1200 according to an embodiment of the present disclosure. Embodiments described herein may be implemented into the communication system 1200 using any suitably configured hardware and/or software. FIG. 6 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1A to FIG. 4. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1A to FIG. 4 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and operations described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the operations disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of coordinated beamforming performed by an access point (AP) device in a wireless local area network (WLAN), comprising:
determining, by the AP device as an initiating AP device, a set of configurations for downlink data transmissions to selected stations, wherein the set of configurations comprises at least one of a transmission channel bandwidth, a number of spatial streams per station, or a number of transmit chains.

2. The method of claim 1, further comprising:
transmitting, by the initiating AP device, a medium access control (MAC) control frame packet to invite participation in coordinated beamforming.

3. The method of claim 2, wherein the MAC control frame packet comprises the set of configurations.

4. The method of claim 2, wherein the MAC control frame packet transmitted by the initiating AP device is an initial control frame or a trigger frame.

5. The method of claim 2, further comprising:
receiving, by the initiating AP device, one or more responding frame packets, wherein the one or more responding frame packets comprises an identification of one or more stations for coordinated beamforming.

6. The method of claim 5, further comprising:
transmitting, by the initiating AP device, a null data packet announcement (NDPA) frame to initiate a sounding operation to acquire a channel state information (CSI) from participating non-AP stations to both the initiating AP device and the responding AP device.

7. The method of claim 6, wherein the NDPA frame transmitted by the initiating AP device further instructs the responding AP device to perform channel sounding.

8. The method of claim 5, further comprising:
initiating a sounding operation to acquire a CSI from participating non-AP stations to both the initiating AP device and the responding AP device.

9. The method of claim 5, further comprising:
transmitting, by the initiating AP device, a trigger frame to trigger a downlink data transmission jointly with the responding AP device using coordinated beamforming.

10. The method of claim 1, wherein coordinated beamforming is terminated by the responding AP device by transmitting a MAC control frame to suspend coordinated beamforming.

11. The method of claim 10, wherein terminating coordinated beamforming comprises:
transmitting, by the initiating AP device, a MAC frame to the responding AP device to suspend coordinated beamforming; or
receiving, by the initiating AP device, the MAC frame from the responding AP device indicating suspension of coordinated beamforming.

12. The method of claim 11, wherein the MAC frame is an NDPA frame or a trigger frame.

13. An AP device, comprising:
a memory;
a transceiver; and
a processor coupled to the memory and the transceiver;
wherein the processor is configured to:
determine a set of configurations for downlink data transmissions to selected stations, wherein the set of configurations comprises at least one of a transmission channel bandwidth, a number of spatial streams per station, or a number of transmit chains.

14. The AP device of claim 13, wherein the transceiver is configured to transmit a medium access control (MAC) control frame packet to invite participation in coordinated beamforming.

15. The AP device of claim 14, wherein the MAC control frame packet comprises the set of configurations.

16. The AP device of claim 14, wherein the MAC control frame packet transmitted by the initiating AP device is an initial control frame or a trigger frame.

17. The AP device of claim 14, wherein the transceiver is configured to receive one or more responding frame packets, wherein the one or more responding frame packets comprises an identification of one or more stations for coordinated beamforming.

18. The AP device of claim 17, wherein the transceiver is configured to transmit a null data packet announcement (NDPA) frame to initiate a sounding operation to acquire a channel state information (CSI) from participating non-AP stations to both the initiating AP device and the responding AP device.

19. The AP device of claim 17, wherein the NDPA frame transmitted by the initiating AP device further instructs the responding AP device to perform channel sounding.

20. The AP device of claim 16, wherein the processor is configured to initiate a sounding operation to acquire a CSI from participating non-AP stations to both the initiating AP device and the responding AP device.
